(19) United States
(12) Patent Application Publication
(10) Pub. No.: US 2008/0146121 A1
(43) Pub. Date: Jun. 19, 2008

(54) PLATEN ASSEMBLY FOR ELECTROCHEMICAL MECHANICAL PROCESSING

(75) Inventors: Omer Ozgun, Sunnyvale, CA (US); Alpay Yilmaz, San Jose, CA (US); Antoine P. Manens, Sunnyvale, CA (US); Lakshmanan Karuppiah, San Jose, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC.

(21) Appl. No.: 11/957,798

(22) Filed: Dec. 17, 2007

Related U.S. Application Data
(60) Provisional application No. 60/870,704, filed on Dec. 19, 2006.

(51) Int. Cl. B24B 7/04; B24B 1/00; B23H 5/08

(52) U.S. Cl. 451/37; 451/530; 205/662

(57) ABSTRACT

A processing pad and platen assembly for processing a substrate is provided. The platen assembly includes a spacer having an upper surface adapted to contact a lower surface of a pad assembly, an upper plate having a recessed area coupled to and disposed below the spacer, and a lower plate coupled to and disposed below the upper plate. The pad assembly includes at least a processing layer having a working surface adapted to process a substrate and an electrode disposed below the working surface of the processing layer. The spacer and the pad assembly have apertures therethrough to provide an electrolyte pathway to the platen assembly for removal of residual materials and other byproducts.

### CROSS REFERENCE TO RELATED APPLICATIONS

This application claims benefit of U.S. Provisional Patent Application Ser. No. 60/870,704, filed Dec. 19, 2006, which is incorporated by reference in its entirety.

### BACKGROUND OF THE INVENTION

1. Field of the Invention

Embodiments of the present invention generally relate to an apparatus and method for processing a surface of a substrate. More particularly, to a processing pad and platen assembly for processing a substrate by electrochemical mechanical processing.

2. Description of the Related Art

In the fabrication of integrated circuits and other electronic devices on substrates, multiple layers of conductive, semiconductive, and dielectric materials are deposited on or removed from a substrate, such as a semiconductor wafer. As layers of materials are sequentially deposited and removed, the substrate may become non-planar and require planarization and/or polishing, in which previously deposited material is removed from the substrate to form a generally even, planar or level surface. The process is useful in removing undesired surface topography and surface defects, such as rough surfaces, agglomerated materials, crystal lattice damage and scratches. The planarization process is also useful in forming features on the substrate by removing excess deposited material used to fill the features and to provide an even or level surface for subsequent deposition and processing.

Electrochemical Mechanical Processing (ECMP) is one exemplary process which is used to remove materials from the substrate. ECMP typically uses a pad assembly having conductive properties and combines physical abrasion with electrochemical activity that enhances the removal of materials. The pad assembly is typically attached to an apparatus having a rotating platen assembly that may be adapted to couple the pad assembly to a power source. The apparatus also has a substrate carrier that holds a substrate, such as a carrier head, that is mounted on a carrier assembly above the pad assembly. The carrier head places the substrate in contact with the pad assembly and is adapted to provide downward pressure, controllably urging the substrate against a surface the pad assembly. The pad assembly is moved relative to the substrate by an external driving force, and the carrier head typically moves relative to the moving pad assembly. A chemical composition, such as an electrolyte, is typically provided to the pad assembly, which enhances electrochemical activity between the pad and the substrate. The ECMP apparatus may effect abrasive and/or polishing activity from frictional movement while the electrolyte combined with the conductive properties of the pad assembly selectively removes material from the substrate.

Although ECMP has produced good results, there is an ongoing effort to develop apparatuses with improved polishing qualities combined with optimal electrical properties that will not degrade over time and require less conditioning, thus providing extended periods of use with less downtime for replacement. Inherent in this challenge is the difficulty in producing a pad assembly that will not react with process chemistry, which may cause degradation, or require excess conditioning.

Maintenance of localized electrical contact to regions of the pad assembly or feature side of the substrate creates challenges in polarization, especially during residual material removal. Additionally, byproducts of the ECMP process affect the electrochemical reaction surface of the pad assembly, which may increase process time and degradation of the pad assembly. Also, if byproducts are not sufficiently removed, the byproducts may contact the surface of the substrate and cause scratches.

Therefore, there is a need for an improved apparatus for electrochemical mechanical processing that maximizes polishing potential of the pad assembly while efficiently removing polishing byproducts.

### SUMMARY OF THE INVENTION

In one embodiment, a platen assembly for processing a substrate is provided. The platen assembly includes a spacer having an upper surface adapted to contact a pad assembly, an upper plate having a recessed area coupled to and disposed below the spacer, and a lower plate coupled to and disposed below the upper plate. The pad assembly includes at least a processing layer having a working surface adapted to process a substrate and an electrode disposed below the working surface of the processing layer. The spacer and the pad assembly have a plurality of apertures formed therethrough to provide an electrolyte pathway to the platen assembly for removal of the byproducts.

In another embodiment, an apparatus for processing a substrate is described. The apparatus includes a pad assembly having a working surface adapted to contact the substrate while processing, a spacer having a plurality of fluid channels formed therein and supporting the pad assembly, and an upper plate having a recessed area for supporting the spacer, wherein at least one aperture is formed through the pad assembly and the spacer.

In another embodiment, an apparatus for processing a substrate is described. The apparatus includes a pad assembly having a first conductive layer and a second conductive layer arranged to be in electrical communication by a plurality of apertures, and a spacer disposed below and supporting the second conductive layer having a plurality of channels in fluid communication with and orthogonal to the plurality of apertures.

In another embodiment, a platen assembly for an electrochemical mechanical processing system is described. The platen assembly includes an upper plate having a lip and a recessed area formed inward of the lip, and a spacer in the recessed area and having a plurality apertures formed therein disposed, wherein the upper plate and the spacer comprise a fluid path formed therebetween.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic side view of a processing station of an electrochemical mechanical processing system;

FIG. 2 is a schematic side view of a portion of one embodiment of the platen assembly of the processing station of FIG. 1;

FIG. 3 is a schematic view of a portion of a platen assembly;

FIG. 4A is a schematic view of bottom surface of a spacer;

FIG. 4B is an exploded view of a portion of the bottom surface of the spacer of FIG. 4A;

FIG. 5 is an exploded perspective view of a portion of the platen assembly showing details of the spacer;

FIG. 6 is an exploded perspective view of a portion of the platen assembly showing details of a trough and spacer;

FIG. 7 is an exploded perspective view of a portion of the platen assembly showing details of a recessed area and the trough;

FIG. 8A is a top view of one embodiment of the pad assembly;

FIG. 8B is an exploded isometric view of a portion of the pad assembly shown in FIG. 8A; and

FIG. 9 is a top view of one embodiment of an electrode of the pad assembly.

To facilitate understanding, identical reference numerals have been used, wherever possible, to designate identical elements that are common to the figures. It is also contemplated that elements disclosed in one embodiment may be beneficially utilized on other embodiments without specific recitation.

### DETAILED DESCRIPTION

A processing pad assembly and platen assembly adapted to enhance uniform deposition/removal of material to/from a substrate is provided herein. The platen assembly is additionally configured to facilitate efficient removal and replacement of electrolyte, and efficient removal of polishing byproducts, thereby improving system processing capacity. Although the embodiments disclosed below focus primarily on removing conductive materials and other materials from a substrate, it is contemplated that the teachings disclosed herein may be used to deposit a conductive material on a substrate by reversing the polarity of the bias.

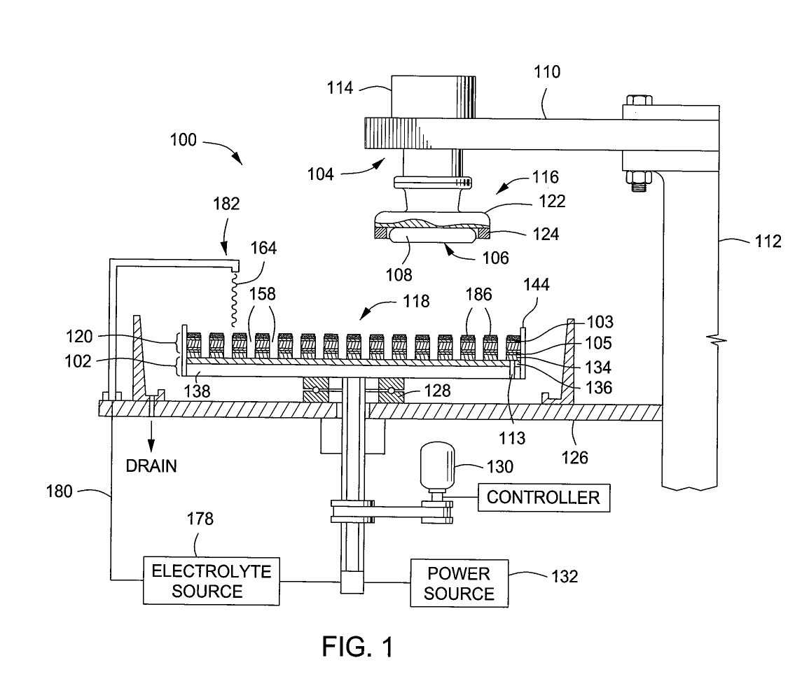

FIG. 1 is a schematic, partial cross-sectional side view of a processing station 100 having one embodiment of a platen assembly 102 of the present invention. The processing station 100 includes a carrier head assembly 104, and a pad assembly 120 disposed on the platen assembly 102. Generally, the pad assembly 120 comprises a processing surface 118 coupled to an upper surface the spacer 134. The pad assembly 120 generally includes a plurality of openings 158 adjacent a plurality of posts or discrete members 186 formed through, formed in, or otherwise coupled to, one or more layers that form the processing surface 118. The pad assembly 120, which will be described in more detail below, may comprise multiple layers, such as a first conductive layer 103 and a second conductive layer 105 that is separated by one or more additional layers that may provide compressibility, stiffness, and/or insulation between the conductive layers. Additionally, an ion permeable membrane (not shown) may be disposed between the first and second conductive layer 103, 105 to prevent or minimize hydrogen bubbles that may form on the second conductive layer from reaching the processing surface. An example of a pad assembly and other elements of an ECMP system is described in U.S. patent application Ser. No. 11/327,526, filed Jan. 5, 2006, which is incorporated by reference in its entirety.

The carrier head assembly 104 is adapted to hold a feature side 106 of a substrate 108 against the pad assembly 120 while relative motion is provided therebetween to remove material from the feature side 106 of the substrate 108. The relative motion may be rotational, lateral, or some combination thereof, and is provided by at least by one or both of the carrier head assembly 104 and the platen assembly 102.

In one embodiment, the carrier head assembly 104 is supported by an arm 110 coupled to a column 112 which extends over the pad assembly 120. The carrier head assembly 104 generally includes a drive system 114 coupled to a carrier head 116. The drive system 114 generally provides at least rotational motion to the carrier head 116. The carrier head 116 additionally may be actuated toward the platen assembly 102 such that the substrate 108 retained in the carrier head 116 may be disposed against the processing surface 118 of the pad assembly during processing. In one embodiment, the carrier head 116 may be a TITAN HEAD™ or TITAN PROFILER™ wafer carrier manufactured by Applied Materials, Inc., of Santa Clara, Calif. Generally, the carrier head 116 comprises a housing 122 and retaining ring 124 that define a center recess in which the substrate 108 is retained. The retaining ring 124 circumscribes the substrate 108 disposed within the carrier head 116, while leaving the feature side 106 exposed, to prevent the substrate from slipping out from under the carrier head 116 during processing. It is contemplated that other carrier heads may also be utilized.

The platen assembly 102 is generally rotationally disposed through a base 126. A bearing 128 is disposed between the platen assembly 102 and the base 126 to facilitate rotation of the platen assembly 102 relative to the base 126. A motor 130, used to rotate the platen assembly 102, may be coupled to the platen assembly 102 to provide rotational motion. The platen assembly 102 generally includes a lip 144 bounding the pad assembly 120, and may form a volume that retains an electrolyte 164. The electrolyte 164 may be dispensed from an electrolyte source 178, through appropriate plumbing and controls, such as a conduit 180, to a nozzle 182 positioned above the pad assembly 120. The electrolyte 164 may form a bath within the volume containing the pad assembly 120 that may be adapted to contain a suitable processing level of electrolyte while rotating. Alternatively, the electrolyte may be provided continuously or at intervals to maintain a suitable amount of electrolyte in the openings 158 and other portions of the pad assembly 120. Electrolyte solutions may include commercially available electrolytes. For example, in copper containing material removal, the electrolyte may include sulfuric acid based electrolytes or phosphoric acid based electrolytes, such as potassium phosphate (K₃PO₄), or combinations thereof. The electrolyte may also contain derivatives of sulfuric acid based electrolytes, such as copper sulfate, and derivatives of phosphoric acid based electrolytes, such as copper phosphate. Electrolytes having perchloric acid-acetic acid solutions and derivatives thereof may also be used. In one embodiment, an anolyte may be provided to the upper portion of the pad assembly 120 and a catholyte may be provided to a lower portion of the pad assembly 120. The anolyte and catholyte may be separated by an ion-permeable membrane as mentioned above.

The electrolyte 164 may be continually flowed to and through the pad assembly 120 and/or the platen assembly 102 during processing to facilitate removal of conductive material and other material from the substrate 108, and removal of byproducts, such as byproducts produced by pad conditioning, may be dispersed or entrained in the electrolyte. In one embodiment, the electrolyte 164 is continually flowed or circulated during processing, wherein the electrolyte is flowed onto and/or into the pad assembly 120 and drained to maintain a suitable level of electrolyte on or in the pad assembly 120 while simultaneously removing materials removed from the substrate 108 and other byproducts. Alternatively, after the electrolyte 164 has reached its processing capacity and is ready for replacement, the spent electrolyte may be drained by opening the control valve allowing for removal of the electrolyte through a drain line. In another embodiment, the platen assembly 102 may be rotated at a higher rotational speed (RPM) so that the spent electrolyte may be moved by centrifugal force over the platen lip 144, or through one or more channels formed in the spacer 134 and/or platen assembly 102 and into a drain. In another embodiment, the platen assembly may be rotated at a higher rotational speed and the spent electrolyte is released through perforations in the platen lip that may be opened and closed by an operator, or controlled by rotational speed. Additionally, spent electrolyte may be released through at least one perforation performing as a drain formed through various layers of the pad assembly 120 and the platen assembly 102.

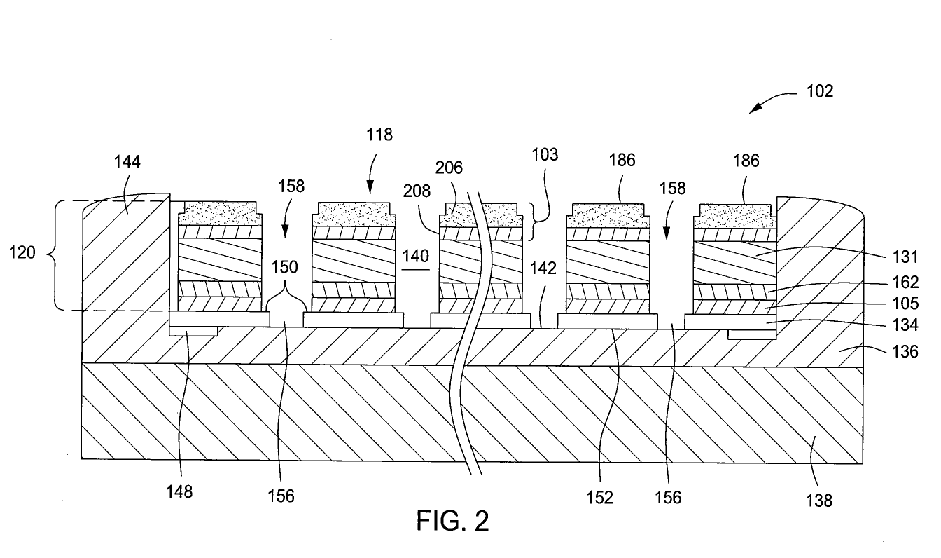

FIG. 2 illustrates a sectional side view of one embodiment of the platen assembly 102 of the present invention. The platen assembly 102 includes the spacer 134, an upper plate 136 and a lower plate 138. The upper plate 136 may have a circular, rectangular or other geometric form and includes a recessed area 140 with a substantially planar top surface 142 for supporting the spacer 134 thereon. The platen assembly 102 also includes a lip 144 that in one embodiment may be at least partially detachable from a portion of the platen assembly 102. The recessed area 140 may also have a circular, rectangular or other geometric form configured to receive the spacer 134 and the pad assembly 120. The spacer 134 is placed in the recessed area 140 and coupled to the upper plate 136. The spacer 134 includes features that provide a fluid path or gap between the pad assembly 120 and the top surface 142 of the upper plate 136.

The recessed area 140 of the upper plate 136 may include a lower recess or trough 148, which may function as a fluid channel along an outer perimeter of the top surface 142 for removal of electrolyte and polishing byproducts, such as particles and residual material from the pad assembly 120 and/or the substrate 108. The trough 148 may be in communication with a drain 113 formed through the platen assembly 102, which may be selectively opened and closed with a control valve (not shown) to control the level of the electrolyte 164 in the pad assembly 120, or always open. The trough 148 is at a lower depth than the recessed area and may comprise an annular channel along the perimeter of the recessed area 140, or may be a segmented annular or arcuate channel, and each segment of the channel may include a separate drain.

The spacer 134 may be fabricated from a rigid material, such as a metal or rigid plastic, and in one embodiment, is fabricated from a metal, such as aluminum. The upper plate 136 may be fabricated from a rigid material, such as a metal or rigid plastic, and in one embodiment, is fabricated from or coated with a dielectric material, such as chlorinated polyvinyl chloride (CPVC). The lower plate 138 is generally fabricated from a rigid material, such as aluminum, and may be coupled to the upper plate 136 by any conventional means, such as a plurality of fasteners or locating pins. Generally, the plurality of locating pins are disposed between the upper and lower plates 136, 138 to ensure alignment therebetween. The upper plate 136 and the lower plate 138 may optionally be fabricated as a single, unitary member.

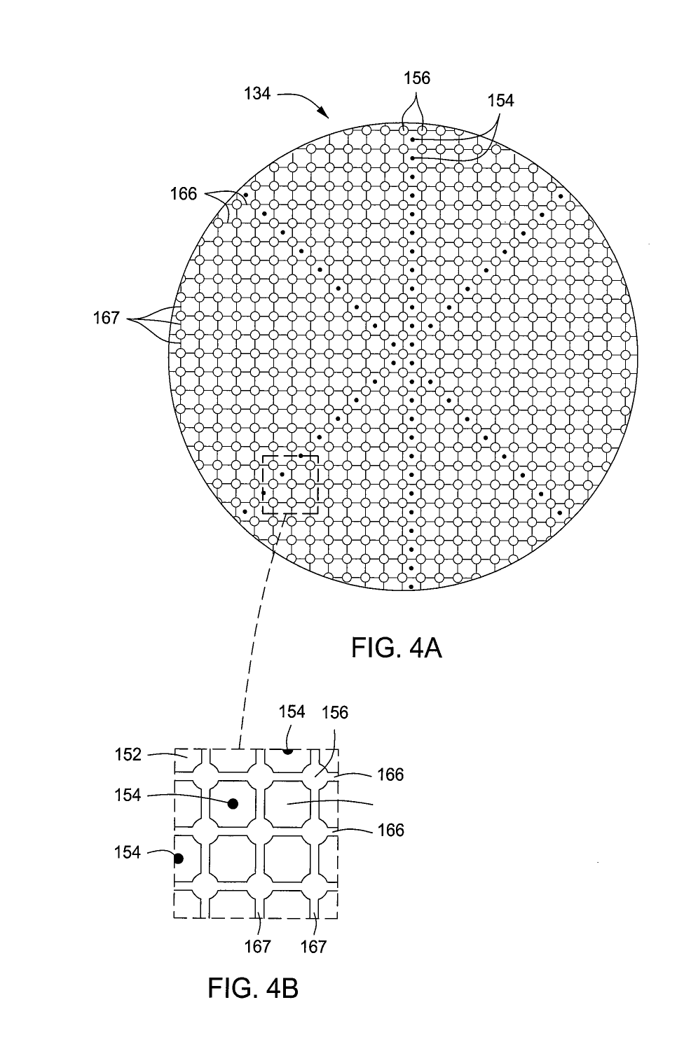

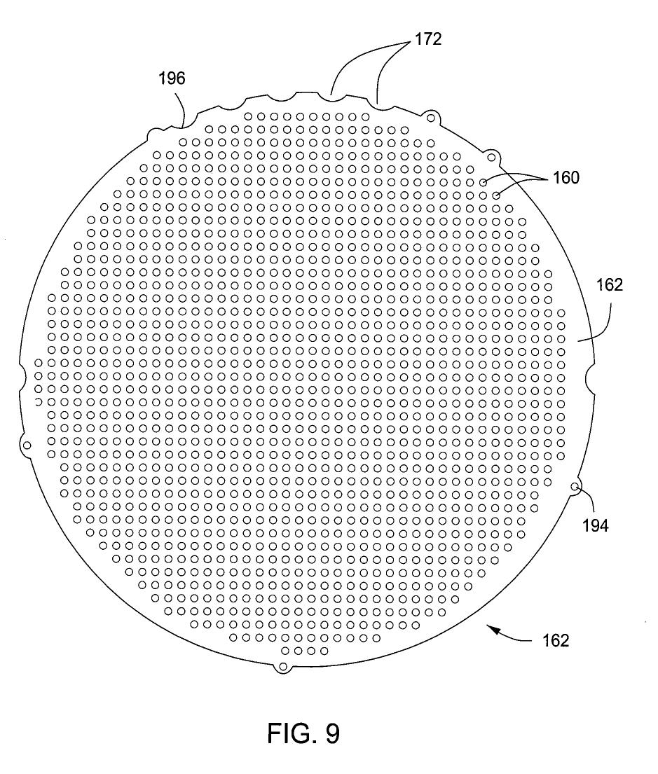

Generally, the pad assembly 120 comprises a processing surface 118, which includes a plurality of apertures 156 adjacent a plurality of posts or discrete members 186 coupled to an electrode 162 (as shown in FIG. 9) or second conductive layer 105. The pad assembly 120 may be coupled to an upper surface 150 the spacer 134. Each of the plurality of discrete members 186 comprise a first conductive layer 103, an insulative or isolation layer 131, and the electrode 162. One or both of the pad assembly 120 and the spacer 134 may be coupled to the upper plate 136 by magnetic attraction, electrostatic attraction, vacuum, adhesives, or the like. In one embodiment, the pad assembly 120 is coupled to the top surface 150 of the spacer 134 by magnetic attraction, electrostatic attraction, vacuum, adhesives, or the like. In another embodiment, the second conductive layer 105 may be coupled to the upper surface 150 by an adhesive that is compatible with process chemistry, such as heat and/or pressure sensitive adhesives known in the art, a hook and loop connector, or any other binder configured to provide static placement and facilitate replacement of the pad assembly 120. In one embodiment, a plurality of magnetic members 154 (shown in FIGS. 4A and 4B) are disposed between the spacer 134 and the recessed area 140 to provide attraction and/or alignment of the pad assembly 120 and the platen assembly 102.

The first conductive layer 103 may include a conductive material 206 coupled to a conductive carrier 208. The conductive carrier 208 generally comprises a conductive material, such as stainless steel, aluminum, gold, silver, copper, tin, nickel, among others. For example, the conductive carrier 208 may be a metal foil, a mesh made of metal wire or metal-coated wire, or a laminated metal layer on a polymer material compatible with the electrolyte, such as a polyimide, polyester, fluoroethylene, polypropylene, or polyethylene sheet. The conductive carrier 208 may also comprise a polymer fabric coated with a conductive material. The first conductive layer 103, the isolation layer 131, and the second conductive layer 105 of the pad assembly 120 may be coupled together or bound, such as by a suitable adhesive.

The conductive material 206 may be made from a conductive material configured to communicate an electrical bias from an upper portion of the pad assembly 120 to the feature side 106 of the substrate 108 during processing. The conductive material 206 may comprise a conductive polymer material, for example, a conventional polishing material, such as polymer based pad materials compatible with the process chemistry, examples of which include polyurethane, polycarbonate, fluoropolymers, PTFE, PTFA, polyphenylene sulfide (PPS), or combinations thereof. The conventional polishing material may be coated, doped, or impregnated with a process compatible conductive material and/or abrasive particles. Alternatively, the conductive material may be a conductive polymer, such as a conductive or dielectric filler material disposed in a conductive polymer matrix or a conductive fabric. In one embodiment, the conductive material is a polymer matrix having a plurality of conductive particles disposed therein. The conductive particles may be particles made of copper, tin, nickel, gold, silver, or combinations thereof. The conductive particles may exhibit a hardness less than, greater than, or equal to that of the conductive material on the feature side 106 of the substrate 108. In one embodiment, the conductive material 206 comprises fine conductive particles, for example, tin particles disposed in a polyurethane binder, or a conductive fabric, such as carbon fibers in a polyurethane binder.

The isolation layer 131 may have a hardness of about 20 Shore A to about 90 Shore A. The isolation layer 131 may be fabricated from polymeric materials, such as polyurethane and polyurethane mixed with fillers, polycarbonate, polyphenylene sulfide (PPS), ethylene-propylene-diene-methylene (EPDM), Teflon™ polymers, or combinations thereof. The isolation layer 131 may also be made of other polishing materials used in polishing substrate surfaces, such as open or closed-cell foamed polymers, elastomers, felt, impregnated felt, plastics, and like materials compatible with the processing chemistries.

The electrode 162 (as shown in FIG. 9) or second conductive layer 105 may be fabricated from a conductive material, such as stainless steel, aluminum, gold, silver, copper, tin, nickel, among others. For example, the second conductive layer 105 may be a metal foil, a mesh made of metal wire or metal-coated wire, or a laminated metal layer or metal coating on a polymer material compatible with the electrolyte, such as a polyimide, polyester, fluoroethylene, polypropylene, or polyethylene sheet. In one embodiment, the second conductive layer 105 is configured to provide conformity and sufficient stiffness to allow the pad assembly to remain substantially flat alone, or in combination with support from the spacer 134. Each of the first and second conductive layers 103, 105 include at least one connector for coupling to one or more power sources adapted to supply a different electrical signal to each of the first and second conductive layers. Each of the at least one connectors may be made of a conductive material and coupled to the pad assembly 120 by any suitable methods, such as soldering, adhesives, or combinations thereof, or integrally formed on the pad assembly. Each of the at least one connectors may be made from nickel, copper, tin, stainless steel, platinum, gold, silver, or combinations thereof.

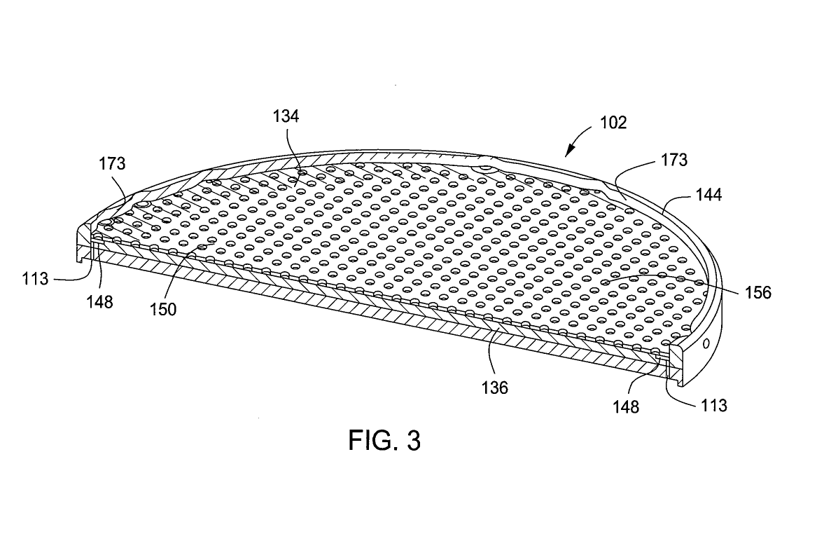

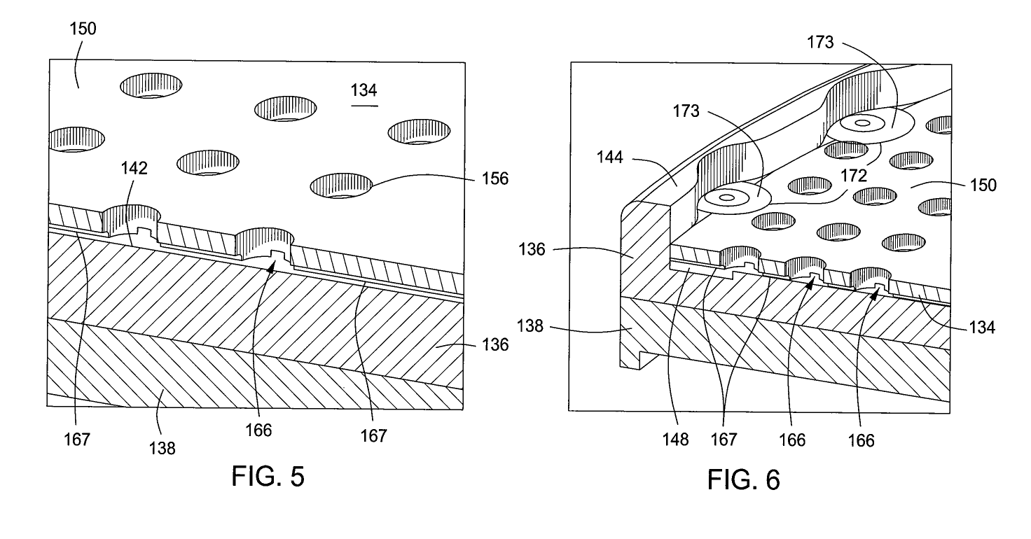

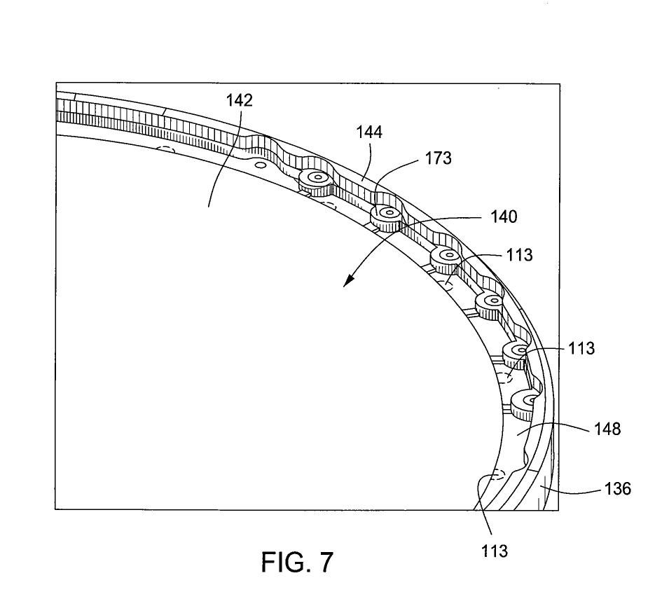

As shown in FIGS. 3-6, the spacer 134 may have a circular, rectangular or other geometric form with a substantially planar top surface 150 and a substantially planar bottom surface 152. The top surface 150 of the spacer supports the pad assembly 120 thereon. The spacer 134 may be a perforated, plate-like member or laminate having a plurality of apertures 156 formed in and through the spacer from the top surface 150 to the bottom surface 152. The plurality of apertures 156 of the spacer are in communication with and at least partially aligned with the plurality of openings 158 in the pad assembly 120. Each of the plurality of apertures 156 may be circular, rectangular, or other geometric shape, and may further include square sidewalls, sloping sidewalls, or a combination thereof. In one embodiment, each of the plurality of apertures 156 is conically shaped. The plurality of apertures 156 may include a uniform size and/or pitch across the spacer 134.

As shown in FIGS. 4A through 6, the bottom surface 152 of the spacer 134 may include a pattern of grooves or first channels 166 and second channels 167. Generally, the channels 166, 167 facilitate the flow of and removal of the electrolyte 164 and any materials removed from the substrate and polishing byproducts that may be entrained therein. For example, the channels 166, 167 provide a fluid gap or flow path for the electrolyte and other materials and byproducts from the pad assembly 120 and polishing process, to the trough 148. From the trough 148, the electrolyte 164 and other materials may be removed from the platen assembly 102 for disposal or to a rejuvenation system that may filter and replenish the electrolyte for recirculation. The channels 166, 167 may be formed partially in or through the bottom surface 152 of the spacer and may take any geometrical form, such as rectangles, squares, triangles, semi-circles, or other suitable profile. The channels 166, 167 may be machined, cast, or formed by other methods.

The channels 166, 167 are in fluid communication with the plurality of apertures 156 and the trough 148. The channels 166, 167 intersect with the apertures 156 and may be arranged in an X-Y pattern or an orthogonal grid pattern, although any pattern may be formed that facilitates or provides a fluid path for the electrolyte 164 and other materials from the apertures 156 to the trough 148. Suitable alternative patterns include a radial pattern, a triangular pattern, concentric rings that may be interconnected, spirals, waves, or a combination thereof, among other configurations. The channels 166 may have a nominal dimension which is smaller than a dimension, such as a diameter, width, and/or depth, of the apertures 156.

In one embodiment, the channels 166, 167 form a portion of a fluid path or fluid channel for electrolyte and other materials from the plurality of apertures 156 to the trough 148, wherein the top surface 142 of the recessed area 140 completes the fluid channel. In other embodiments (not shown), the channels 166, 167 may be formed within the body of the spacer 134, or a portion of the channels 166, 167 may be formed in the top surface 142 of the recessed area 140. For example, the channels 166, 167 may be conduits formed within the spacer 134, wherein the electrolyte and other materials from the polishing process do not contact the recessed area 140. Alternatively, for example, the channels 166, 167 may be formed at least partially in the top surface 142 of the recessed area 140. Corresponding channels may be formed in the bottom surface 152 of the spacer 134. In other embodiments, the channels may be formed in the top surface 142 of the recessed area 140 and the bottom surface 152 of the spacer 134, which may be planar, may enclose the channels. In any embodiment, at least a portion of the plurality of channels 166, 167 are adapted to form a fluid path between the plurality of apertures 156 and the trough 148.

In operation, electrolyte 164 flows to and through the pad assembly 120 during processing, and materials from the substrate, and other byproducts, may flow through the apertures 156 and to the channels 166, 167. During processing, the platen assembly 102 and pad assembly 120 is rotating, which applies a motive force or dynamic to the electrolyte 164 and other materials that may be carried by the electrolyte or entrained therein. In one embodiment, centrifugal force from the movement of the platen assembly 102 is applied to the electrolyte 164 and other materials causing the electrolyte and other materials to flow to the trough 148 through the channels 166, 167. From the trough 148, the electrolyte and other materials may be drained by a drain or drains formed in the platen assembly 102.

The spacer 134 may also include a plurality of connectors having an opening (not shown) for coupling to the platen assembly and a plurality of cutouts 172 allowing for connection and/or alignment of the spacer 134 and the pad assembly 120 to the platen assembly 102. For example, the cutouts 172 may form a void or area for connecting the pad assembly 120 to the platen assembly 102, such as an electrical connection to provide power to conductive portions of the pad assembly 120 disposed in or on protruded portions 173 disposed on the inner surface of the lip 144. Alternatively and additionally, the cutouts 172 may be sized and adapted to mate with the protruded portions 173 to facilitate alignment of the spacer 134 relative to the platen assembly 102. The connectors on the spacer may be made of a process resistant material, such as the same material used for the spacer 134.

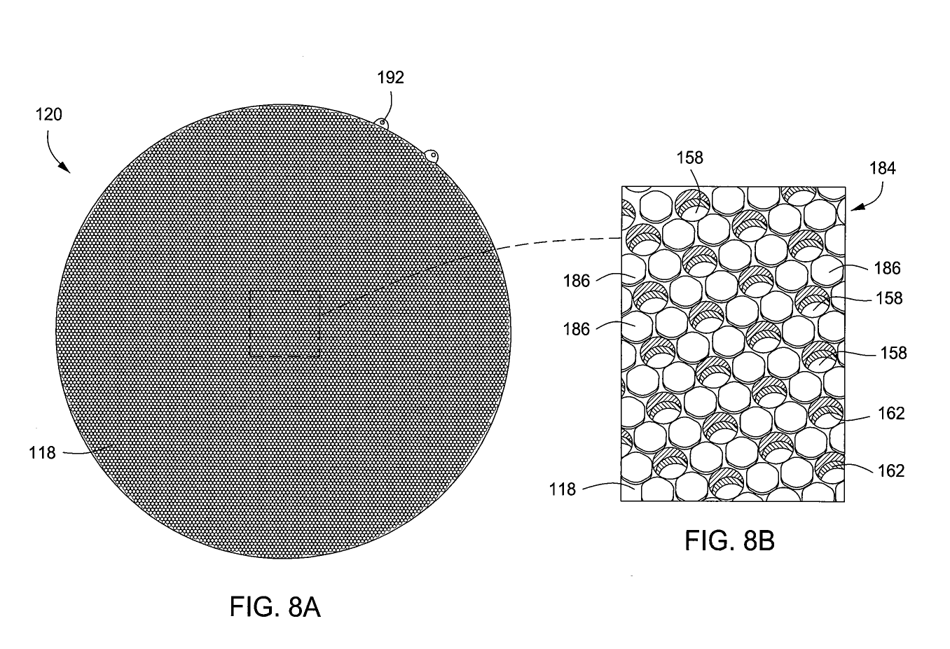

As depicted in FIGS. 8A and 8B, the processing surface 118 has a working surface 184 that, in one embodiment, is adapted to contact and remove conductive materials and other materials from the feature side 106 of the substrate 108 during processing. The working surface 184 may be roughened, embossed, stepped, smooth, or a combination thereof, or otherwise patterned to facilitate distribution of a polishing fluid or electrolyte over the surface of the pad assembly 120. Patterns may include grooves, embossing, cutouts, perforations, and the like. In one embodiment, the processing surface 118 may be perforated which increases the material removal rate from the substrate during processing. The processing surface 118 includes a plurality of posts or discrete members 186 (as shown in side view of FIGS. 1 and 2) adapted to process the substrate 108 adjacent to the plurality of openings 158, which are configured to receive the electrolyte and facilitate flow of the electrolyte and other materials.

The discrete members 186 may include any geometrical shape, such as ovals, rectangles, triangles, hexagons, octagons, or combinations thereof, or be conical in shape. The plurality of openings 158 generally define an open area or percentage open area within the area the pad assembly 120. In one embodiment, the open area of the pad assembly is between about 40% to about 60%. In one embodiment, each of the plurality of openings 158 defines a functional cell 190, which is adapted to perform as an electrochemical cell when electrolyte is provided to the pad assembly and a differential electrical bias is applied to the conductive layers within the pad assembly 120.

In one embodiment, the working surface 184 may comprise the same materials described above in reference to the conductive material 206 or alternatively, the working surface 184 may be dielectric, for example, polyurethane or other polymer. In one embodiment, the working surface 184 may include conductive material or include conductive contact elements extending therefrom. For example, the working surface 184 may be fabricated from a dielectric material and include conductive contacts or conductive members disposed therein or extending therethough. Examples of pad assemblies and processing layers that may be adapted to benefit from the invention are described in U.S. Pat. No. 6,991,528, filed Jun. 6, 2003 and issued Jan. 31, 2006; U.S. patent application Ser. No. 11/327,527, filed Jan. 5, 2006; and U.S. patent application Ser. No. 10/455,895, filed Jun. 6, 2003, which published as United States Patent Publication No. 2004/0020789 on Feb. 5, 2004, all of which are hereby incorporated by reference in their entireties.

In this embodiment, the processing surface 118 and other portions of the pad assembly 120 may be formed by compression molding, male/female, punch/die, or other methods known in the art to form the plurality of discrete members and the plurality of openings. The plurality of openings 158 may be extended through to the electrode to allow the electrolyte to be in communication with the platen assembly. The plurality of openings 158 may be uniformly distributed across the surface of the processing layer or the openings 158 may be grouped into different regions, or zones, of varying open area percentage with a uniform pattern within each respective zone. It should be noted that although the openings 158 depicted in FIGS. 9A-9B are circular, any shape or form of opening which allows the electrolyte to flow through the processing layer and to come into contact with the electrode and substrate during processing is contemplated. The processing surface 118 may also include one or more connectors 192 having an opening for coupling to a mating electrical connection on the platen assembly 102.

As illustrated in FIGS. 2 and 9, the second conductive layer 105 or electrode 162 is generally positioned between the processing surface 118 and the spacer 134 of the platen assembly 102. The electrode 162 may be a perforated plate-like member or laminate having a plurality of holes 160 formed in the electrode 162. The plurality of holes 160 in the electrode are in communication and at least partially aligned with the plurality of holes 156, 158 in the processing surface 118 and spacer 134, respectively, and allow the electrolyte to flow therethrough and come in contact with the platen assembly 102 to facilitate flow of the electrolyte 164 and other materials to the channels 166, 167 and the trough 148.

The plurality of holes 160 may be uniformly distributed across the surface of the electrode 162. It should be noted that although the holes 160 depicted in FIG. 9 are round, any shape or form of opening which allows the electrolyte to flow through the electrode is contemplated. Furthermore, although the pattern of the plurality of holes 160 should be uniform, the holes may be grouped into different regions, or zones, of varying open area percentage with a uniform pattern within each respective zone as long as a portion of the plurality of holes 160 are at least partially aligned with the openings 158 in the processing surface 118 and the apertures 156 in the spacer 134. The electrode 162 may also include a plurality of connectors 194 having an opening for coupling to the platen assembly and a plurality of cutouts 196 for coupling to the processing layer.

The pad assembly 120 is at least partially permeable to electrolyte at least between the electrode 162 and the working surface 184 of the processing surface 118. The pad assembly 120 is adapted to electrically bias the substrate 108 during processing by electrically coupling to a power source, while the electrode 162 of the pad assembly 120 is coupled to another terminal of the power source to apply a different electrical bias. The electrolyte, which is introduced and is disposed on the pad assembly 120, completes an electrical circuit between the substrate 108 and the electrode 162 of the pad assembly 120, which, in one embodiment, assists in the removal of material from the surface of the substrate 108.

The electrode 162, the processing surface 118, and any additional layers of the pad assembly 120 may be combined into a unitary assembly by the use of adhesives, bonding, compression molding, or the like. In one embodiment, adhesive is used to attach the pad assembly together. The adhesive generally is a pressure sensitive adhesive or a temperature sensitive adhesive and should be compatible with the process chemistry as well as with the different materials used for the electrode 162 and processing surface 118. The adhesive may have a strong physical and/or chemical bond to the electrode 162 and processing surface 118. However, selection of the adhesive may also depend upon the form of the electrode 162 and processing surface 118. The pad assembly 120 is disposed on a top surface of the spacer of the platen assembly 102 and may be held there by magnetic attraction, static attraction, vacuum, adhesives, or the like.

In operation, the pad assembly 120 is disposed on the spacer 134, which is supported in the platen assembly 102. The electrolyte 164 is flowed to the pad assembly 120 and the substrate 108 in the carrier head contacts the processing surface 118 of the pad assembly 120. Power from a power source is then applied to the first conductive layer 103 and the second conductive layer 105 or electrode 162. Relative motion between the substrate 108 and the platen assembly 102 may be provided while the substrate is controllably urged toward the pad assembly 120. Conductive materials and other materials are removed from the feature side 106 of the substrate 108, and the removed materials, and any other byproducts, such as byproducts produced by pad conditioning, may be dispersed or entrained in the electrolyte. The electrolyte 164 flows in and through the pad assembly through at least a portion of the plurality of openings 158 in the pad assembly 120, the plurality of holes 160 in the electrode 162, and the plurality of apertures 156 in the spacer 134, which may be at least partially assisted by gravitational forces. The electrolyte 164, and any materials removed from the substrate and other byproducts, may be flowed through at least a portion of the plurality of channels 166, 167 to the trough 143, which may be caused at least in part by centrifugal force. From the trough 143, the electrolyte 164, and any materials from the substrate and other by products, may be drained or otherwise removed from the platen assembly 102.

During processing, the electrolyte may continually or intermittently be flowed to the pad assembly 120, and the electrolyte and other materials may continually or intermittently be flowed or drained from the platen assembly 102, which may enhance removal rate and the electrical properties of the pad assembly 120. For example, materials from the substrate and/or processing byproducts may at least partially affect the performance of the second conductive layer 105 or electrode 162 by accumulation of materials on a reaction surface of the electrode 162. By continually or intermittently flowing the electrolyte 164, the material accumulation on the reaction surface of the electrode 162 may be minimized or eliminated. In this manner, the electrical properties of the pad assembly 120 may be enhanced. This may increase the removal rate of material from the substrate, thus shortening the polishing or planarizing process, which may enhance throughput.

While the foregoing is directed to the illustrative embodiment of the present invention, other and further embodiments of the invention may be devised without departing from the basic scope thereof, and the scope thereof is determined by the claims that follow.

1. An apparatus for processing a substrate, comprising:
a pad assembly having a working surface adapted to contact the substrate while processing;
a spacer having a plurality of fluid channels formed therein and supporting the pad assembly; and
an upper plate having a recessed area for supporting the spacer, wherein at least one aperture is formed through the pad assembly and the spacer.

2. The apparatus of claim 1, wherein the spacer includes a apertures in fluid communication with the plurality of fluid channels.

3. The apparatus of claim 2, wherein the upper plate forms a portion of the plurality of channels.

4. An apparatus for processing a substrate, comprising:
a pad assembly having a first conductive layer and a second conductive layer arranged to be in electrical communication by a plurality of apertures; and
a spacer disposed below and supporting the second conductive layer having a plurality of channels in fluid communication with and orthogonal to the plurality of apertures.

5. The apparatus of claim 4, wherein the plurality of channels includes a first plurality of channels and a second plurality of channels that are orthogonal to the first plurality of channels.

6. A platen assembly for an electrochemical mechanical processing system, comprising:
an upper plate having a lip and a recessed area formed inward of the lip; and
a spacer in the recessed area and having a plurality apertures formed therein disposed, wherein the upper plate and the spacer comprise a fluid path formed therebetween.

7. The apparatus of claim 6, wherein the fluid path comprises a plurality of channels.

8. The apparatus of claim 7, wherein the plurality of channels are formed in a lower surface of the spacer.

9. The apparatus of claim 7, wherein the plurality of channels are formed in an upper surface of the recessed area.

10. The apparatus of claim 6, further comprising:
one or more annular channels formed in the recessed area.

11. The apparatus of claim 6, further comprising:
one or more annular channels formed in a perimeter of the recessed area.
